(19) United States
(12) Patent Application Publication
(10) Pub. No.: US 2004/0085584 A1
(43) Pub. Date: May 6, 2004

(54) Image forming apparatus and image forming method

(75) Inventor: Jun Sasano, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/284,262

(22) Filed: Oct. 31, 2002

(51) Int. Cl. H04N 1/50; H04N 1/40; H04N 1/23; H04N 1/48

(52) U.S. Cl. 358/2.1; 358/515; 358/1.13

(57) ABSTRACT

When a request for black-and-white copying is conducted on color copying input instruction, a main control section uses color image information obtained by reading an original to perform printing processing of color copying, and further uses a color/black-and-white image converting section to convert the color image information into black-and-white image information, thereby performing printing processing of black-and-white copying.

### BACKGROUND OF THE INVENTION

The present invention relates to an image forming apparatus and image forming method for forming an image of a color copying machine or the like capable of performing not only color copying but also black-and-white copying.

Conventionally, in a color copying machine, a need exists for performing black-and-white copying at the same time with color copying. For example, in the case where a salesperson creates a proposal for client, the proposal with colors is created for excellent appearance. However, since color copying is expensive, the same original is copied in black-and-white for staffs in his/her company so that cost reduction is conducted.

In this case, color copying is once conducted, and then the same original is again copied in black-and-white. Since outputting is different between color copying and black-and-white copying, the same original has had to be read twice for color copying and black-and-white copying.

### BRIEF SUMMARY OF THE INVENTION

It is an object of the present invention to provide an image forming apparatus and image forming method capable of forming color and black-and-white images by only one reading of an original.

According to an aspect of the present invention, there is provided an image forming apparatus for forming an image by reading an image of an original, comprising: a first instruction section which instructs original reading for reading an image of an original by separating it into a plurality of colors to output color image information, and color image formation; a second instruction section which instructs black-and-white image formation of the same original instructed by the first instruction section; a reading section which reads an image of an original by separating it into a plurality of colors to output color image information according to an instruction of the first instruction section; a converting section which converts the color image information output from the reading section into black-and-white image information according to an instruction of the second instruction section; and an image forming section which forms a color image on the basis of the color image information output from the reading section according to the first instruction, and forms a black-and-white image on the basis of the black-and-white image information converted in the converting section according to the second instruction.

According to another aspect of the present invention, there is provided an image forming method for forming an image by reading an image of an original, comprising: instructing original reading for reading an image of an original by separating it into a plurality of colors to output color image information, and color image formation and black-and-white image formation in the same original; reading an image of an original by separating it into a plurality of colors to output color image information according to the instruction; converting the output color image information into black-and-white image information; forming a black-and-white image on the basis of the converted black-and-white image information; and forming a color image on the basis of the output color image information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a schematic configuration of a color copying machine according to an image forming apparatus of the present invention;

FIG. 2 is a plan view showing a configuration of an operation panel;

FIG. 3 is a flow chart for explaining operations for performing color copying and black-and-white copying for the same original; and

FIG. 4 is a display example of a touch panel.

### DETAILED DESCRIPTION OF THE INVENTION

Hereinafter, an embodiment according to the present invention will be described with reference to the drawings.

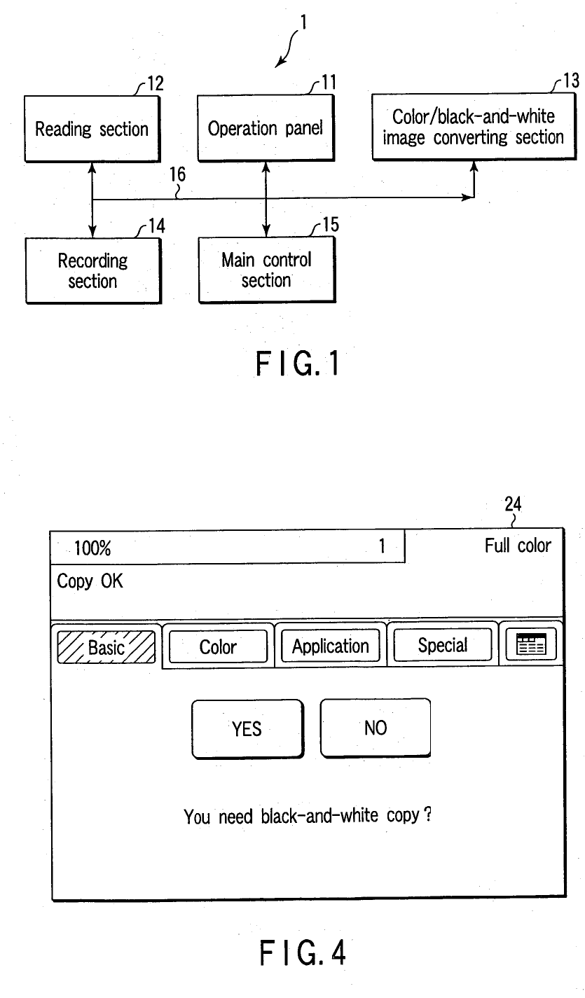

FIG. 1 shows a schematic configuration of a color copying machine according to an image forming apparatus of the present invention. A color copying machine 1 is configured with an operation panel 11, a reading section 12, a color/black-and-white image converting section 13, a recording section 14, a main control section 15, and a bus 16.

The operation panel 11 performs input instructing of copying.

The reading section 12 is a scanner for reading an image of an original. This reading section 12 reads a color image on the original by color-separating it with a color line CCD sensor or the like, and converts it into signals of color materials such as toners or inks of the colors to output the same.

For example, color separation signals of R (red), G (green), and B (blue) of the color image are read. A predetermined calculation is performed for the color separation signals of R, G, and B to be converted into the signals of C (cyan), M (magenta), and Y (yellow) of the color materials. Further, in the case where color printing is performed, when the three colors of C, M, and Y are used, gray close to black is generated. Therefore, a signal K (black) for black portion is generated in order that the black portion can be correctly printed as black pixels. Therefore, the color signals of C, M, Y, and K are output as color image information.

The color/black-and-white image converting section 13 converts color image information into black-and-white image information. In other words, the color/black-and-white image converting section 13 uses the color signals of C, M, Y, and K as the color image information output from the reading section 12 to convert into the black-and-white image information.

Further, the reading section 12 is provided with an original platen (not shown) made of transparent glass on which an original is placed, where an automatic draft feeder (ADF) (not shown) for automatically feeding an original on this original platen is arranged.

The recording section 14 is a printer for performing color and black-and-white printing.

The main control section 15 conducts the entire control of the color copying machine 1.

The bus 16 connects the operation panel 11, the reading section 12, the color/black-and-white image converting section 13, the recording section 14, and the main control section 15.

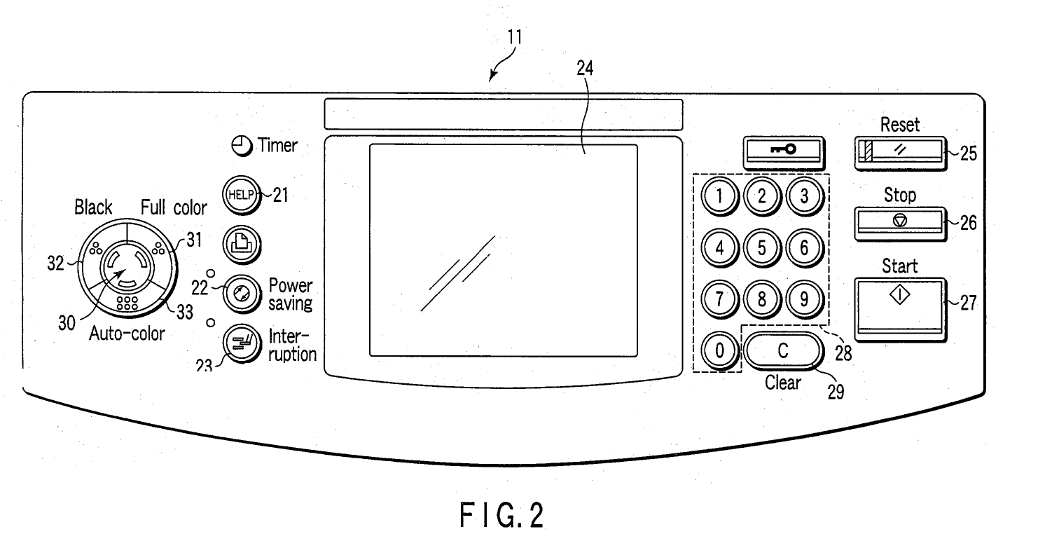

FIG. 2 shows an appearance configuration of the operation panel 11. The operation panel 11 comprises a help button 21, a power saving button 22, an interruption button 23, a touch panel 24, a reset button 25, a stop button 26, a start button 27, numeric keys 28, a clear button 29, and a color mode selection button 30.

When the help button 21 is pressed, a message indicating an operation procedure is displayed on the touch panel 24.

In the case where copying is not conducted for a while, the power saving button 22 is pressed to enter the power saving state so that all the lamp displays turn off.

When it is desired to copy another original halfway through the already started copying operation, the interruption button 23 is pressed.

The touch panel 24 has a liquid crystal display to display the state or operation procedure of the copying machine, and various instructions to the user with characters and illustrations.

When the reset button 25 is pressed, all the selected modes are released to return to the initial setting.

The stop button 26 is used to stop the reading operation and the copying operation.

The start button 27 is pressed when copying is started.

The numeric keys 28 are pressed when the number of copies is input.

The clear button 29 is used to correct the number such as the number of copies input by the numeric keys 28.

The color mode selection button 30 is constituted of a full color button 31, a black button 32, and an auto-color button 33. The full color button 31 is directed for full color copying irrespective of the kind of original. The black button 32 is directed for black-and-white copying irrespective of the kind of original. The auto-color button 33 is directed for automatically determining the kind of original so that a color original is copied with full color and a black-and-white original is copied in black-and-white.

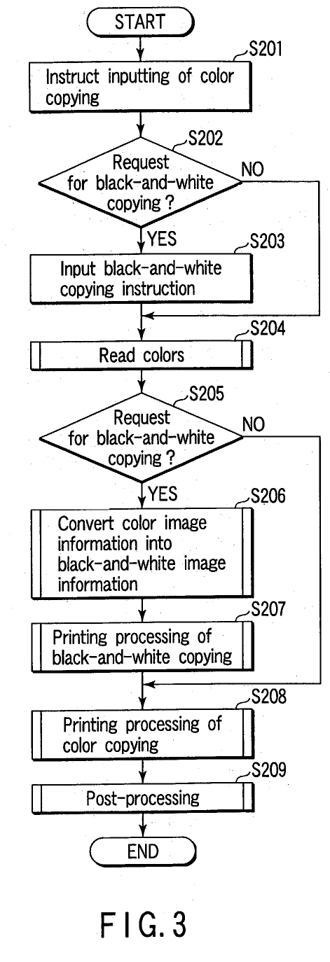

Next, in such a configuration, the operations for performing color copying and black-and-white copying for the same original will be described with reference to a flow chart of FIG. 3.

At first, in the color copying machine 1, an original is set on the reading section 12 and input instructions of copying are received at the operation panel 11 (step 201). Here, suppose the full color button 31 of the operation panel 11 is pressed so that input instructions of color copying such as the number of pieces of paper, size of paper, and the like are conducted.

When the input instructions of color copying are completed, the main control section 15 performs display on whether or not black-and-white copying is also required on the touch panel 24 (step 202).

FIG. 4 shows a display example of the touch panel 24. When a YES key is pressed, it is determined that the black-and-white copying is also required so that a processing proceeds to step 203, and when a NO key is pressed, the processing proceeds to step 204.

In step 203, required input instructions of black-and-white copying are received in the operation panel 11.

When the start button 27 is pressed, the main control section 15 controls color reading operation of the original set on the reading section 12 (step 204).

Subsequently, the main control section 15 controls the color reading since the full color button 31 is pressed, and determines whether or not a request for black-and-white copying has been conducted in step 202 (step 205).

In step 205, when it is determined that the request for black-and-white copying has been conducted, the main control section 15 uses the color/black-and-white image converting section 13 to convert the color image information read in step 204 into the black-and-white image information (step 206).

The main control section 15 uses the converted black-and-white image information to control printing processing of the black-and-white copying in the recording section 14 (step 207).

Subsequently, the main control section 15 uses the color image information read in step 204 to control printing processing of the color copying in the recording section 14.

Finally, the main control section 15 controls post-processing of this copying operation (step 209), and completes a series of operations.

In the above embodiment, the printing processing of the black-and-white copying is previously controlled, but the printing processing of the color copying may be previously controlled.

As described above, according to the embodiment of the present invention, the printing processings of color copying and black-and-white copying can be conducted by one reading operation of an original.

Further, the aforementioned color/black-and-white image converting section is provided on a reading apparatus such as a scanner or the like, and thereby it is possible to provide a reading apparatus capable of outputting color image information and outputting black-and-white image information by only one reading of an original.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus for forming an image by reading an image of an original, comprising:
a first instruction section which instructs original reading for reading an image of an original by separating it into a plurality of colors to output color image information, and color image formation;
a second instruction section which instructs black-and-white image formation of the same original instructed by the first instruction section;
a reading section which reads an image of an original by separating it into a plurality of colors to output color image information according to an instruction of the first instruction section;
a converting section which converts the color image information output from the reading section into black-and-white image information according to an instruction of the second instruction section; and
an image forming section which forms a color image on the basis of the color image information output from the reading section according to the first instruction, and forms a black-and-white image on the basis of the black-and-white image information converted in the converting section according to the second instruction.

2. An image forming apparatus according to claim 1, wherein the first instruction section and the second instruction section are each an operation panel configured of a plurality of hard buttons and a liquid crystal display having a touch panel.

3. An image forming apparatus according to claim 1, wherein the reading section reads color separation signals of R (red), G (green), and B (blue), a predetermined calculation is performed for the color separation signals of R, G, and B to convert into color signals of C (cyan), M (magenta), and Y (yellow), and a color signal K (black) is further generated so that the color signals of C, M, Y, and K are output as color image information.

4. An image forming apparatus according to claim 3, wherein the converting section uses the color signals of C, M, Y, and K as the color image information output from the reading section to convert into black-and-white image information.

5. An image forming apparatus according to claim 1, wherein the image forming section is a printer which forms a color image on the basis of color image information, and forms a black-and-white image on the basis of black-and-white image information.

6. An image forming apparatus according to claim 1, wherein the image forming section performs black-and-white image formation in preference to color image formation.

7. An image forming method for forming an image by reading an image of an original, comprising:
instructing original reading for reading an image of an original by separating it into a plurality of colors to output color image information, and color image formation and black-and-white image formation in the same original;
reading an image of an original by separating it into a plurality of colors to output color image information according to the instruction;
converting the output color image information into black-and-white image information;
forming a black-and-white image on the basis of the converted black-and-white image information; and
forming a color image on the basis of the output color image information.

8. An image forming method for forming an image by reading an image of an original, comprising:
instructing original reading for reading an image of an original by separating it into a plurality of colors to output color image information, and color image formation;
instructing black-and-white image formation of the instructed same original;
reading an image of an original by separating it into a plurality of colors to output color image information according to the original reading instruction;
converting the output color image information into black-and-white image information according to the black-and-white image forming instruction; and
forming a black-and-white image on the basis of the converted black-and-white image information, and forming a color image on the basis of the output color image information.

9. A reading apparatus for reading an original, wherein outputting of color image information and outputting of black-and-white image information are enabled by only one reading of an original.

10. A reading apparatus according to claim 9, comprising a converting section for converting color image information into black-and-white image information.
